(19) United States
(12) Patent Application Publication
(10) Pub. No.: US 2012/0207994 A1
(43) Pub. Date: Aug. 16, 2012

(54) CARBON-METAL OXIDE-SULFUR CATHODES FOR HIGH-PERFORMANCE LITHIUM-SULFUR BATTERIES

(76) Inventors: Donghai Wang, State College, PA (US); Zhongxue Chen, State College, PA (US); Tianren Xu, State College, PA (US)

(21) Appl. No.: 13/371,946

(22) Filed: Feb. 13, 2012

Related U.S. Application Data
(60) Provisional application No. 61/441,724, filed on Feb. 11, 2011.
(60) Provisional application No. 61/553,366, filed on Oct. 31, 2011.

(51) Int. Cl. B32B 3/00; H01M 4/485; C04B 35/64; H01M 4/58

(52) U.S. Cl. 428/219; 252/182.1; 252/506; 429/231.8; 264/618

(57) ABSTRACT

Embodiments presented herein provide a new approach for high-performance lithium-sulfur battery by using novel carbon-metal oxide-sulfur composites. The composites may be prepared by encapsulating sulfur particles in bifunctional carbon-supported metal oxide or other porous carbon-metal oxide composites. In this way, the porous carbon-metal oxide composite confines sulfur particles within its tunnels and maintain the electrical contact during cycling. Furthermore, the uniformly embedded metal oxides in the structure strongly adsorb polysulfide intermediates, avoid dissolution loss of sulfur, and ensure high coulombic efficiency as well as a long cycle life.

### CROSS-REFERENCE TO RELATED APPLICATIONS

This application claims priority to U.S. provisional patent application no. 61/441,724, filed on Feb. 11, 2011, and to U.S. provisional patent application no. 61/553,366, filed on Oct. 31, 2011. Both of those applications are incorporated by reference herein.

### BACKGROUND OF THE INVENTION

1. Field of the Invention

Embodiments of the invention relate to carbon-metal oxide-sulfur composites, as well as methods of making them. Further embodiments relate to objects that may be made from these composites, including high-performance lithium-sulfur batteries and battery components.

2. Description of the Related Art

Many consider rechargeable lithium-ion batteries to be favorable energy storage devices for both existing and future upcoming hybrid electric-vehicles (HEV) and full electric vehicles (EV). Unfortunately, many lithium-ion batteries are unsatisfactory for one or more of a number of reasons. For example, they may lack a desired high energy density, may lack a long cycle lifetime, or may have a number of these drawbacks. In many cases these drawbacks are the result of use of a cathode that is inadequate for the task of high energy density, long cycle duty. Common cathode materials include lithium cobalt oxide, lithium manganese oxide, lithium mixed oxides with nickel, lithium iron phosphate, and lithium vanadium oxide.

In part because of its extremely high theoretical capacity of 1675 mAh/g, sulfur has been proposed as a promising cathode candidate. Unfortunately, existing Li-sulfur systems are unsatisfactory for at least two reasons. First, despite its high theoretical capacity, sulfur exhibits very poor electrical conductivity. Second, the polysulfide shuttle effect limits the utility of sulfur cathodes. The polysulfide shuttle effect is caused by the high solubility of the polysulfide anions during cycling of the battery. This leads to rapid decay of capacity and relatively low coulombic efficiency.

Many solutions have been proposed for increasing the conductivity of the sulfur. Typically these solutions involve incorporating the sulfur into cathodes in conjunction with carbon or a conducting polymer. Unfortunately, neither the carbon nor the conducting polymer is able to ameliorate the polysulfide shuttle effect.

Extensive attempts have been devoted to improving the electrochemical performance of sulfur electrodes. These include attempts at electrolyte modification, use of additives, and anode protection. Recently, considerable attention has been focused on immobilizing the polysulfides within the cathode by addition of metal oxides, such as Mg_{0.6}Ni_{0.4}O, V₂O₅, SiO₂, and Al₂O₃. Performance of the sulfur cathodes obtained in these attempts was largely suboptimal because the approaches relied on simple, inhomogeneous mixtures of metal oxides and sulfur.

### BRIEF SUMMARY OF THE INVENTION

Embodiments presented herein provide a new approach for high-performance lithium-sulfur battery by securing sulfur particles in bifunctional porous carbon-supported metal oxide to form carbon-metal oxide-sulfur composites. In these composites the ordered porous carbon confines sulfur particles within its tunnels and maintain the electrical contact during cycling. Furthermore, the embedded metal oxides in the carbon structure, which are typically embedded uniformly, strongly adsorb polysulfide intermediates, avoid dissolution loss of sulfur, and ensure high coulombic efficiency as well as a long cycle life. Various metal oxides in the carbon-metal oxide-sulfur composites offer promising alternatives to greatly improve the performance of Li/S batteries.

### DETAILED DESCRIPTION OF THE FIGURES

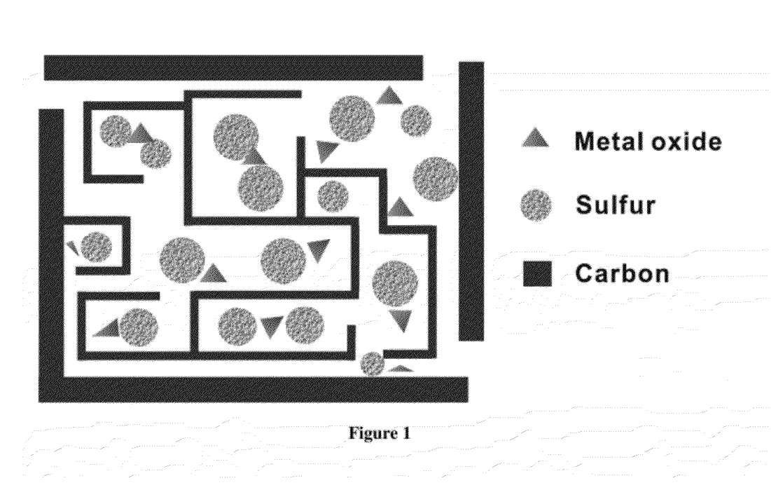

FIG. 1 shows a possible configuration of a carbon-metal oxide-sulfur composite of an embodiment of the invention.

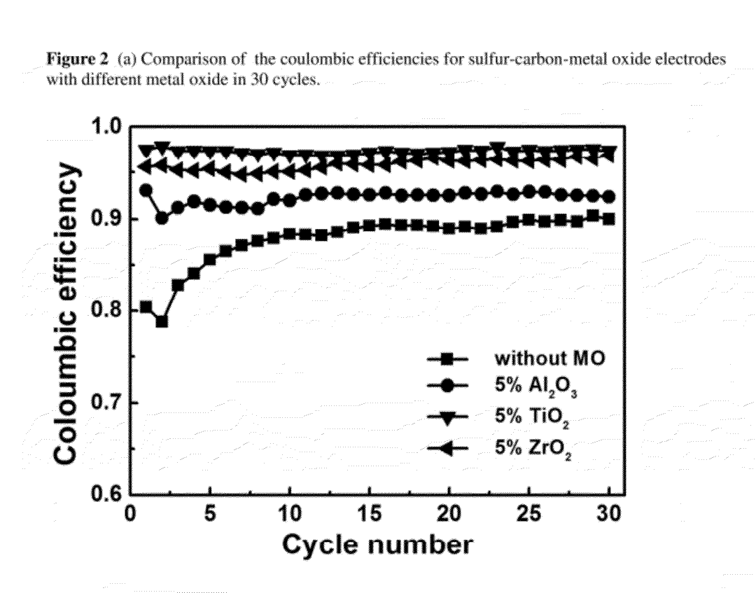

FIG. 2 shows comparison of coulombic efficiencies for different electrodes in 30 cycles.

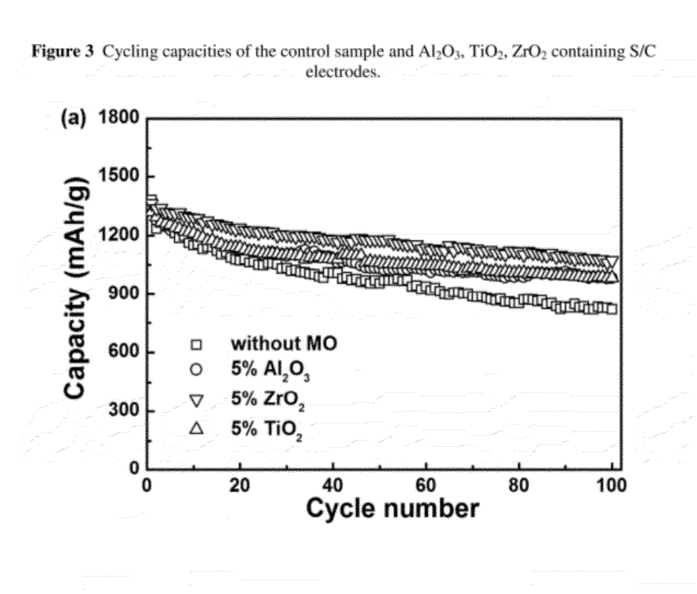

FIG. 3 shows cycling capacities of the control sample and Al₂O₃, TiO₂, ZrO₂-containing carbon-metal oxide-sulfur electrodes.

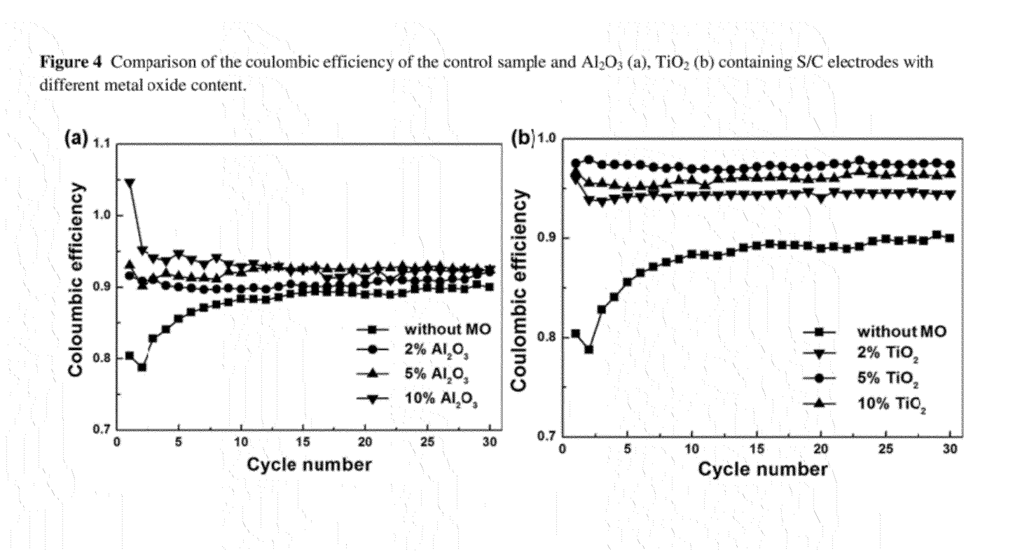

FIG. 4 shows a comparison of the coulombic efficiency of the control sample and Al₂O₃ (a), TiO₂ (b) containing S/C electrodes with different metal oxide content.

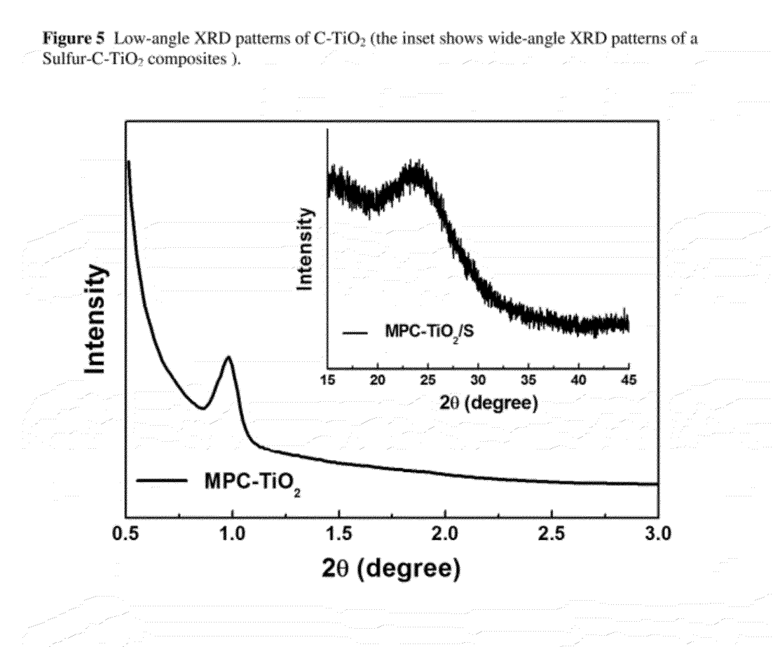

FIG. 5 shows a low angle XRD pattern for the MPC-TiO₂ formed in Example 1. The inset shows wide-angle XRD patterns of C-TiO₂-Sulfur composites.

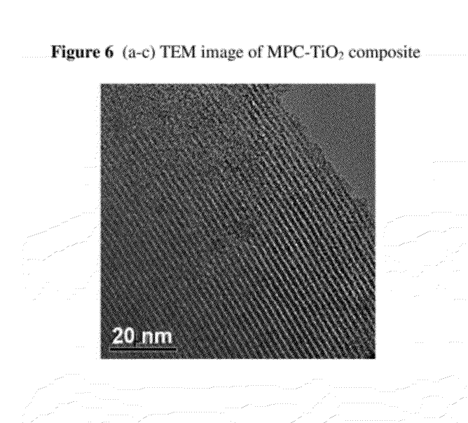

FIG. 6 show a representative TEM image of the MPC-TiO₂ formed in Example 1. Sulfur is not included.

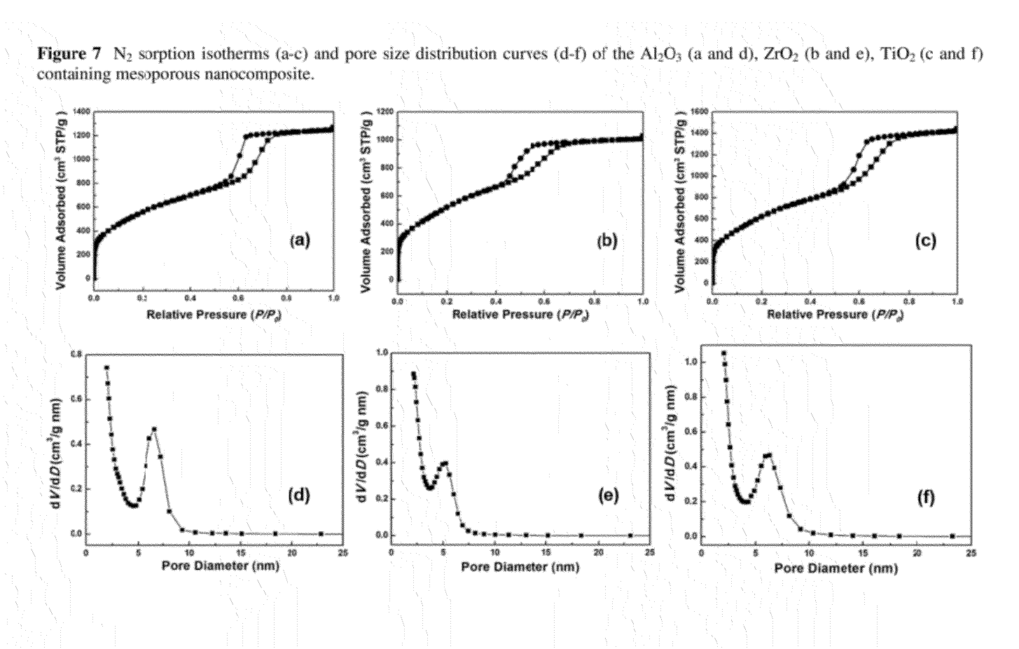

FIG. 7 shows N₂ sorption isotherms (a-c) and pore size distribution curves (d-f) of the Al₂O₃ (a and d), ZrO₂ (b and e), TiO₂ (c and f) containing nanoporous nanocomposite. Sulfur has not been impregnated on these composites.

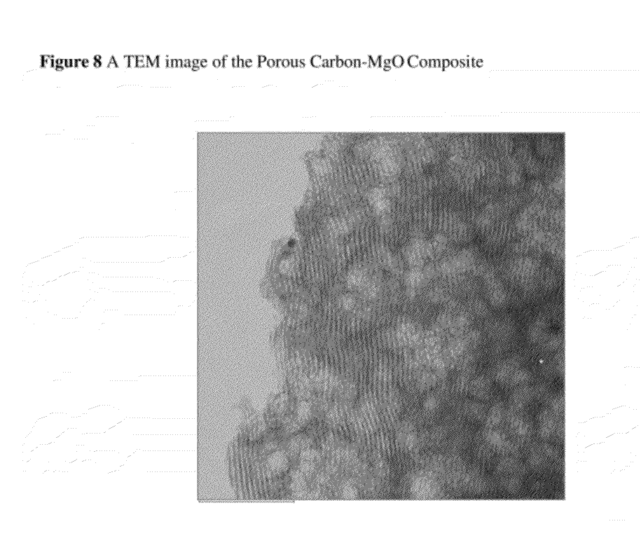

FIGS. 8 shows representative TEM images of a porous carbon-MgO composite.

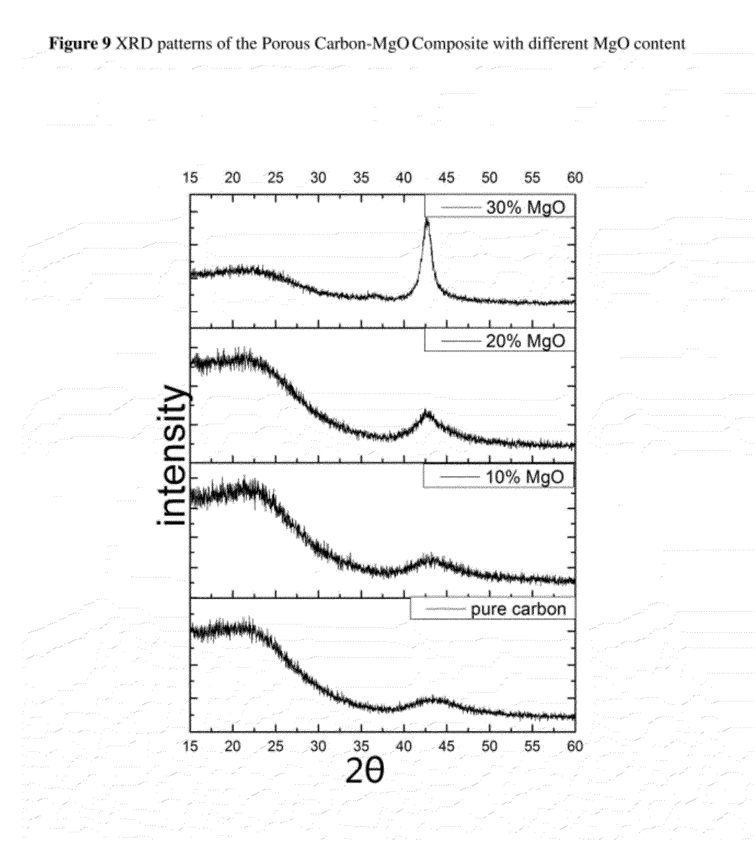

FIG. 9 shows a high angle X-ray diffraction (“XRD”) pattern for the porous C-MgO composite with different content of MgO formed in Example 2. In this case the composite is a mesoporous carbon, or “MPC.”

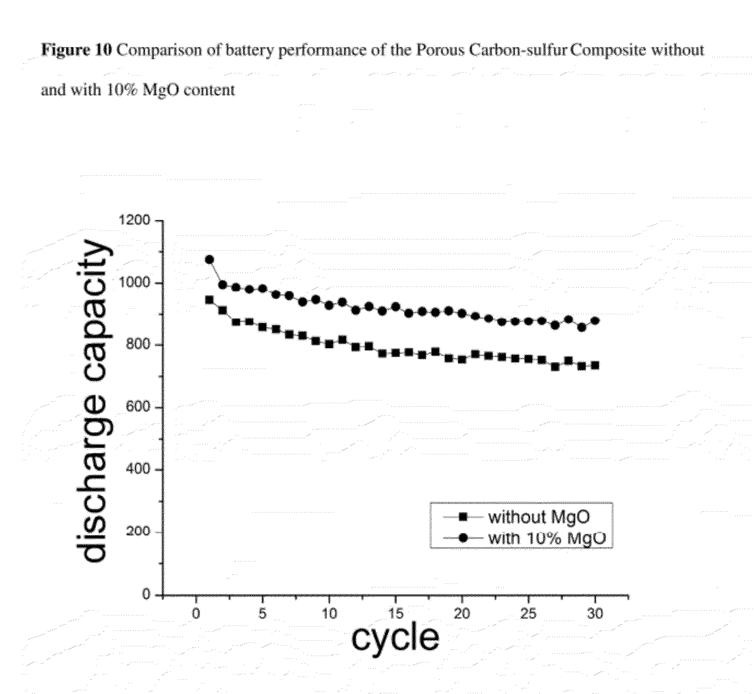

FIG. 10 shows comparison of battery cycling performance of the porous carbon-sulfur composite without and with 10% MgO content.

### DETAILED DESCRIPTION OF THE INVENTION

Embodiments of the invention provide carbon-metal oxide composites and methods of making and using them. One particularly preferred use involves the inclusion of the carbon-metal oxide composites as a cathode for use in a lithium-sulfur battery.

### I. Carbon-Metal Oxide Composites

Embodiments of the invention typically include pores and channels that allow the introduction of sulfur to the pores and channels and, by extension, incorporation of sulfur in the composites and any structures made therefrom. These pores and channels are designed to help entrap sulfur particles, preventing or hindering their movement and thereby decreasing the detrimental sulfur shuttle effect.

The size of the channels may be varied depending on the method that is used to create the composites. Typical embodiments have a hierarchical pore structure including micropores, mesopores and macropores. For example, the composites may be mesoporous, having a mean pore diameter of between 2 nm and 20 nm. They may also be nanoporous, having a mean pore diameter less than 100 nm. The phrase “nanocomposite” may also be used to describe the nanoporous structures.

Of course, one skilled in the art will, with the benefit of this disclosure, recognize that the materials and methods disclosed herein may be used to create composites of varying pore sizes and for various applications. In one embodiment the diameter of mesopores is between 2 nm and 20 nm. In another embodiment the diameter of micropores is less than 2 nm. In a further embodiment the diameter of nanopores is less than 100 nm. In a further embodiment the diameter of macropore is larger than 20 nm. The BET surface area in a preferred embodiment is between 1900 m²/g and 3000 m²/g. The pore volume in a preferred embodiment is between 1.7 cm³/g and 10 cm³/g.

Unfortunately, inclusion of sulfur in carbon channels and pores alone is not sufficient to decrease the shuttle effect to the degree necessary to create an effective cathode for a lithium-sulfur battery. We have found, however, that the shuttle effect may be effectively decreased by inclusion of a metal oxide in the composite. Typically the metal oxide is present uniformly throughout the composite, where “uniformly” indicates that the metal oxide particles per unit volume are the same. In other embodiments the metal oxide particles per unit volume of the composite may vary by up to 5%, up to 10%, or more across the composite.

A number of metal oxides may be used in embodiments of the invention. Although typical embodiments include predominantly one metal oxide, in some embodiments more than one metal oxide may be included. For example, embodiments may include one or more metal oxides selected from titanium (IV) oxide, zirconium (IV) oxide, aluminum (III) oxide, vanadium (VI) oxide, nickel (II) oxide, magnesium (II) oxide, copper (II) oxide, chromium (III) oxide, cobalt (II) oxide, manganese (IV) oxide, iron (III) oxide, molybdenum (VI) oxide, cerium (IV) oxide, manganese (III) oxide, silicon (IV) oxide, zinc (II) oxide, boron (III) oxide, bismuth (III) oxide, and tin (II) oxide. These metal oxides may be amorphous or crystalline depending the crystallization process during calcination.

Of course, articles of the invention are not limited by the method of inclusion of the metal oxide; however, in some embodiments the metal oxide is included in the composite but introducing one or more metal oxide precursors to a carbon composite prior to the thermopolymerization of the composite. Suitable metal oxide precursors may include, for example, but are not limited to titanium (IV) isopropoxide, titanium (IV) chloride, titanium (IV) n-butoxide, zirconium (IV) isopropoxide, zirconium (IV) n-butoxide, zirconium (IV) oxychloride, aluminum (III) isopropoxide, aluminum (III) nitrate, aluminum (III) (sec-BuO)₃, ammonium metavanadate, vanadium (V) oxytrichloride, vanadium (IV) oxide bis(2,4-pentanedionate), nickel (II) chloride, nickel (II) acetate, magnesium (II) chloride, magnesium (II) nitrate, magnesium (II) acetate, copper (II) nitrate, chromium (III) nitrate, cobalt (II) nitrate, cobalt (II) acetate, manganese (II) nitrate, manganese (II) acetate, iron (III) nitrate, iron (III) ethoxide, ammonium heptamolybdate tetrahydrate, peroxomolybdenum, cerium (IV) isopropoxide, cerium (IV) t-butoxide, cerium (IV) nitrate, cerium (III) chloride, cerium (III) acetate, tetramethyl orthosilicate, tetraethyl orthosilicate, tetrapropyl orthosilicate, and tetrabutyl orthosilicate, zinc (II) chloride, zinc (II) nitrate, zinc (II) acetate, bismuth (III) isopropoxide, bismuth (III) chloride, bismuth (III) nitrate, bismuth (III) acetate, boric acid, tin (II) chloride, and tin (II) acetate.

In a preferred embodiment, sulfur is adsorbed in the pore structure of the carbon-metal oxide composite to form carbon-metal oxide-sulfur composites. Typically the sulfur is elemental sulfur. The sulfur is usually sized so that it has a mean particle diameter at least as large as or larger than the mean diameter of the pores in the carbon/metal oxide composite. One example of a carbon-metal oxide composite that contains sulfur is shown in FIG. 1. As with the metal oxide, certain embodiments of the invention are not defined by how sulfur is included in the composite.

### II. Preparation of a Carbon-Metal Oxide Composite

In some embodiments the carbon-metal oxide composite is prepared as set forth below. One or more of metal oxide precursors are dissolved in organic solvents with an acidic catalyst and a carbon precursor. Organic solvents useful in embodiments of the invention include, but are not limited to, methanol, ethanol, tetrahydrofuran, aether, chloroform, dichloromethane, benzene, and methylbenzene. In one preferred embodiment, ethanol is used. Useful acidic catalysts include one or more protonic acids that may be selected to adjust the production rate of metal oxide. These include, for example, but are not limited to, hydrochloric acid, methanoic acid, acetic acid, oxalic acid, propanoic acid, and benzoic acid. In one preferred embodiment, hydrochloric acid is used. The mix process in the early reaction period is performed under continuous stirring. In some embodiments the reaction temperature may vary from 10° C. to 60° C., and the reaction time may vary from 10 min to 3 days.

The specific choice of polymer precursor for the carbon source will be made by weighing several factors. These include selecting for low molecular weight in an early reaction period, which encourages dissolution in organic solvent and integration with other components. After heating, further crosslinking of the polymer occurs, forming a superpolymer with high molecular weight. The polymer precursor may further comprise one or more oligomers including, for example, but not limited to, phenolic resin, polyimide, polypyrrole, polyacrylonitrile, and polyacrylamide. The molecular weight of oligomers may vary from 200 to 5000. The weight ratio of the polymer precursors and non-ionic surfactant in the preferred mixtures may vary from about 0.5 to 2.0. The weight ratio of the polymer precursors and silica precursors in the preferred mixtures may vary from about 0.15 to 10. In one preferred embodiment phenolic resin is used as the carbon precursor.

A pore template is then dissolved in the organic solvent/acidic catalyst/metal oxide precursor mixture. Silica precursors and polymer precursors are added in sequence with continuous stirring to obtain a homogeneous solution. Pore templates are useful to create the voids and channels in the carbon composite. Useful pore templates include silica, cationic, anionic, non-ionic surfactants with and without swelling agents, polymeric surfactant with and without swelling agents, polymer spheres, and silica colloids. Swelling agents may be, for example, 1,3,5-triisopropylbenzene, tetramethylbenzidin, and 1,3,5-trimethylbenzene.

The non-ionic surfactant or other pore template used in synthesis of carbon-silica-metal oxide functions as a template to provide ordered structure after removal by calcination. Examples of the surfactants that may be used include, but are not limited to, CTAB (Cetyl trimethylammonium bromide), block copolymer Polystyrene-poly-ethlene oxide, P123 (EO₂₀PO₇₀EO₂₀), F127 (EO₁₀₆PO₇₀EO₁₀₆), Brij35 (C₁₂H₂₅EO₂₃), and Brij56 (C₁₆H₃₃EO₁₀) and other non-ionic polymeric surfactants. The surfactant in the preferred mixtures may be added in an amount from about 4% to 10% by weight. In one embodiment, F127 (EO₁₀₆PO ₇₀EO₁₀₆) is preferred used.

Silicon dioxide may also be included during production. The incorporation of silicon dioxide into the carbon-metal oxide structure in this invention is to produce micropores and/or macropores after removal of the silicon dioxide. This enhances the pore volume and surface area of the resulting structure. Examples of silica precursors for generating micropores may be used include, but are not limited to, tetramethyl orthosilicate, tetraethyl orthosilicate, tetrapropyl orthosilicate, and tetrabutyl orthosilicate. The weight ratio of the acidic catalyst and silica precursor in the preferred mixtures may vary from about 0.2 to 0.004. In one embodiment, tetraethyl orthosilicate is employed. Examples of silica colloids for generating macropores may be used include, but are not limited to silica colloids with diameter of 20-70 nm and spherical/rod-like shaped colloids.

The solvent is evaporated and the resulting composition is heated at low temperatures, creating a flaxen and transparent film or membrane. The solvent evaporation and low temperature heating of the homogeneous solution in this invention is to promote further crosslinking of oligomers. The heating temperature may vary from 60° C. to 120° C. The heating time may vary from 8 hours to 3 days.

High-temperature calcination is then carried out to remove the organic templates and carbonize the polymer precursors. High temperature calcination is carried out to remove the non-ionic surfactant or other pore former and carbonize the polymer precursors. The calcination temperature may vary from 350° C. to 1200° C. The calcination time may vary from 3 hours to 3 days.

The resulting material, if it contains silicon dioxide, may be treated through acid or base etching to completely or partially remove the precursor from the composite. The acid or base will react with silicon dioxide, but will not ruin the carbon-metal oxide structure. For example, suitable acids or bases that may be used include but are not limited to hydrofluoric acid and sodium hydroxide. In one preferred embodiment, hydrofluoric acid is used.

The metal oxide may be added during the above process in any of a number of ways. For example, metal oxide may be included by atomic layer deposition. Liquid phase impregnation may also be used to include a metal oxide precursor prior to or after calcination. By varying the method of inclusion of the metal oxide, the arrangement of the metal oxide in the composite may be influence, allowing the structure to tend to formation of ordered and non-ordered matrices.

### III. Preparation of a Carbon-Metal Oxide-Sulfur Composite

After the carbon-metal oxide composite is prepared, sulfur is added to prepare the composition for use as an electrode precursor. Typically the synthesis of carbon-metal oxide-sulfur nanocomposite is accomplished by sulfur impregnation into carbon-metal oxide composite is accomplished with a melt-diffusion strategy. Sulfur melts at 113° C., and the melting sulfur will diffuse into the pores of the structure at high temperature. The heating temperature for the sulfur and carbon-metal oxide mixture may vary from 150° C. to 400° C. The heating time may vary from 3 h to 3 days. The mass ratio between sulfur and carbon-metal oxide composite may vary from 0.1 to 100. The inert atmosphere employed may be used to protect sulfur from oxidation. Many gases may be used in embodiments of the invention. For example, suitable gases include but are not limited to, argon, and nitrogen.

Elemental sulfur may be mixed with carbon-metal oxide composites at different ratios (the mass ratio of sulfur to carbon-metal oxide can be between 0.1-100) and heated in inert atmosphere (e.g., N₂, He, Ar) to an elevated temperature (e.g., 150° C.) for a period of time and then cooled to room temperature (e.g., 25° C.). This allows the sulfur to be entrapped in the pore structure of carbon-metal oxide to form carbon-metal oxide-sulfur composites with controlled sulfur content. In these composites the metal oxides assist in the retention of the sulfur.

IV. Preparation of a Li-S Cathode from a carbon-metal oxide-sulfur composites

For the carbon-metal oxide-sulfur composites to be useful in a lithium-sulfur cathode, the composites must be incorporated in a cathode. The sulfur impregnated carbon-metal oxide material is mixed with conductive carbon and polymer binder in different ratios for preparing a working electrode, as discussed below. All the electrochemical testing of the electrode material is performed using 2016-type coin cells with lithium foil as the counter electrode and 1M LiTFSI in 1, 3-dioxolane (DOL) and dimethoxyethane (DME) (e.g., volume ratio of 1:1) as the electrolyte.

The sulfur impregnated carbon-metal oxide material is mixed with conductive carbon and polymer binder for preparing a working electrode in this invention. Examples of conductive carbon that may be used include, but are not limited to, Super P, acetylene carbon black, CNT, KS-6, V7, XC-72, EC 600D, and EC 300J. Examples of polymer binder that may be used include, but are not limited to, polyvinylidene fluoride (PVDF), polytetrafluoroethylene (PTFE), carboxymethyl cellulose (CMC), methyl cellulose (MC), polyvinyl alcohol (PVA), and fluorinated ethylene propylene (FEP). The mass ratio of sulfur impregnated carbon-metal oxide composite in the working electrode may vary from 0.1 to 0.92. The mass ratio of conductive carbon may vary from 0.04 to 0.8. The mass ratio of polymer binder may vary from 0.04 to 0.2. All of these amounts are given by weight of the total cathode.

### V. Function of the Resulting Electrode

The performance of Li-S battery has historically been limited by a severe polysulfide shuttle effect due to the high solubility of the polysulfide anions during cycling. This may occur despite the use of carbon channels in an attempt to immobilize the sulfur. The metal oxide additive disclosed herein, however, provides the ability to adsorb polysulfide intermediates, avoid dissolution loss of sulfur, and ensure high coulombic efficiency as well as a long cycle life.
   A. Coulombic Efficiency

The coulombic efficiency of the sulfur cathode greatly improves after adding metal oxide into the structure. Selected embodiments present in this invention, as presented in FIG. 2, show that a stable coulombic efficiency of 93%, 96%, 98% is obtained for Al₂O₃, ZrO₂, and TiO₂ containing S/C cathode compared to 80% for the control sample. Coulombic efficiency for embodiments of the invention may range from 90%-99%, 93%-98%, and 94%-96%.
B. Cycling Performance

Embodiments of the invention that include Al₂O₃, ZrO₂, or TiO₂-containing S/C cathodes can maintain 73%, 79%, 75% of their initial capacity up to 100 cycles. This is a significant improvement over the 60% that is obtained for the control sample. This improvement is attributable to the inclusion of the metal oxide and the resulting reduction of the sulfur shuttle effect. This is shown, for example, in FIG. 3.
C. Varying Metal Oxide Content

Different metal oxides with a range in content (from 1% to 10% by weight of the electrode) greatly improve the coulombic efficiency of sulfur cathode compared to the control sample. This is shown, for example, in FIG. 4.

### EXAMPLES

### I. Example 1

Example 1 describes the preparation of one exemplary embodiment of the invention.

Materials used in Example 1 included poly(propylene oxide)-block-poly(ethylene oxide)-block-poly(propylene oxide) triblock copolymer Pluronic® F127 (M_{w}=12600, PEO₁₀₆PPO₇₀PEO₁₀₆, from Sigma-Aldrich; PLURONIC® is a registered trademark of BASF Corporation); tetra-ethyl orthosilicate (TEOS), phenol, formalin solution (37 wt %), buffered HF solution, Titanium (IV) isopropoxide (95%), Zirconium (IV) isopropoxide(99.9%-Zr), Aluminum isopropoxide (98%), NaOH, HCl, and ethanol were also used.

The resol precursor (Mw<500) is prepared according to Liu's method (J. Am. Chem. Soc. 2006, 128, 11652-11662). In one embodiment, 12.2 g of phenol is melted at 40-42° C. in a flask and mixed with 2.6 g of 20 wt % NaOH aqueous solution under stifling. After 10 min, 20.1 g of formalin (37 wt % formaldehyde) was added dropwise at 45° C. Upon further stirring for 1 h at 72° C., the mixture was cooled to room temperature and the pH value was adjusted to about 7.0 by HCl solution. After water was removed by rotary evaporator at 50° C., the final product was dissolved in ethanol (20 wt % ethanolic solution).

The ordered polymer-silica and carbon-silica composites were then prepared. In a typical preparation, block copolymer F127 is dissolved in ethanol with 0.2 M HCl and stirred for 1 h at 40° C. to afford a clear solution.

Next, TEOS and the ethanolic solution of the resol are added in sequence. After being stirred for 2 hours, the mixture is transferred into dishes. The mixture is left overnight to evaporate ethanol and heated 24 h at 100° C. in an oven to thermopolymerize. The as-made products, which are films or membranes, are scraped from the dishes and ground into fine powders. Calcination is carried out in a tubular furnace at 350° C. for 3 h and at 900° C. for 2 h under Ar flow to carbon-silica composites. The heating rate is 1° C./min below 600° C. and 5° C./min above 600° C.

Silica is then removed from the structure to obtain porous carbon. The carbon-silica nanocomposites are immersed in 2 wt % HF solutions overnight. In this way, silicas are removed leaving porous carbon that contains both micropores and mesopores. The product is washed by distilled water six times and dried at 80° C. in an oven.

In a typical preparation of carbon-metal oxide composite, Titanium (IV) isopropoxide (or Zirconium (IV) isopropoxide or Aluminum (III) isopropoxide) is first dissolved in ethanol with 0.2 M HCl, then the porous carbon is mixed with the metal oxide precursor solution and stirred for 1 h at 40° C. to afford impregnation of metal oxide precursor into the porous carbon.

The metal oxide precursor containing carbon is then calcined in a tubular furnace at 450° C. for 3 h under Ar flow to carbon-metal oxide composites. The heating rate is 1° C./min.

The sulfur is incorporated into the nanocomposite by a melt-diffusion strategy. The carbon-metal oxide composite is ground together with sulfur. The mixture is heated at 150° C. for 6 h and 300° C. for 2 h in an Ar-filled cylindrical container.

Results are shown graphically in FIGS. 5, 6, and 7. The XRD pattern of sulfur-metal oxide-carbon composite in FIG. 5 shows amorphous features without crystalline sulfur structures. The TEM image in FIG. 6 shows ordered porous structure of carbon-TiO₂ porous composites. Nitrogen adsorption in FIG. 7 shows microporous and mesoporous structure in the those cases. The performance of the carbon-metal oxide-sulfur nanocomposite cathode in this invention is substantially better than that of cathodes reported to date. This excellent performance makes it capable for Li-sulfur batteries application.

### II. Example 2

Example 2 shows the preparation of another exemplary embodiment of the invention. Materials used in Example 2 included poly(propylene oxide)-block-poly(ethylene oxide)-block-poly(propylene oxide) triblock copolymer Pluronic® F127 (Mw=12600, PEO₁₀₆PPO₇₀PEO₁₀₆, from Sigma-Aldrich; PLURONIC® is a registered trademark of BASF Corporation); tetra-ethyl orthosilicate (TEOS), phenol, formalin solution (37 wt %), buffered HF solution, magnesium acetate, colloidal silica suspension (particle size of 10 nm-20 nm)), NaOH, HCl, and ethanol were also used.

The resol precursor (Mw<500) is prepared according to Liu's method (J. Am. Chem. Soc. 2006, 128, 11652-11662). In one embodiment, 12.2 g of phenol is melted at 40-42° C. in a flask and mixed with 2.6 g of 20 wt % NaOH aqueous solution under stirring. After 10 min, 20.1 g of formalin (37 wt % formaldehyde) is added dropwise at 45° C. Upon further stirring for 1 h at 72° C., the mixture is cooled to room temperature and the pH value is adjusted to about 7.0 by HCl solution. After water is removed by rotary evaporator at 50° C., the final product is dissolved in ethanol (20 wt % ethanolic solution).

The ordered mesoporous polymer-silica and carbon-silica nanocomposites are then prepared. In a typical preparation, block copolymer F127 is dissolved and stirred for 1 h at 40° C. to afford a clear solution.

Next, colloidal silica, TEOS and the ethanolic solution of the resol are added in sequence. After being stirred for 2 hours, the mixture is transferred into dishes. The mixture is left overnight to evaporate ethanol and heated 24 h at 100° C. in an oven to thermopolymerize. The as-made products, which are films or membranes, are scraped from the dishes and ground into fine powders. Calcination is carried out in a tubular furnace at 350° C. for 3 h and at 900° C. for 2 h under Ar flow to get mesoporous carbon-silica nano-composites. The heating rate is 1° C/min below 600° C. and 5° C/min above 600° C., respectively.

Silica is then removed from the structure. The carbon-silica nanocomposites containing metal oxides are immersed in 2 wt % HF solutions overnight. In this way, silicas are removed leaving porous carbon. The product is washed by distilled water six times and dried at 80° C. in an oven.

In a typical preparation of carbon-magnesium oxide composite, magnesium acetate is first dissolved in ethanol, then the porous carbon is mixed with the metal oxide precursor solution under sonication and stirred for 5h at 50° C. to afford impregnation of magnesium oxide precursor into the porous carbon.

The magnesium oxide precursor containing carbon is then calcined in a tubular furnace at 500° C. for 3 hours under Ar flow to carbon-metal oxide composites. The heating rate is 5° C./min.

The sulfur is incorporated into the nanocomposite by a melt-diffusion strategy. The porous carbon-magnesium oxide composite, is ground together with sulfur. The mixture is heated at 150° C. for 6 h and 300° C. for 2 h in an Ar-filled cylindrical container.

Results are favorable. They are shown in FIGS. 8, 9 and 10. TEM image in FIG. 8 shows porous structure of carbon-MgO porous composites. XRD pattern sulfur-MgO-carbon composite in FIG. 9 show crystalline MgO features without observing crystalline sulfur. Cycling performance in FIG. 10 shows higher capacity in carbon-sulfur-MgO composite than that of carbon-sulfur.

Patents, patent applications, publications, scientific articles, books, web sites, and other documents and materials referenced or mentioned herein are indicative of the levels of skill required for this invention. Inclusion of a document in this specification is not an admission that the document represents prior invention or is prior art for any purpose.

We claim:

1. A carbon-metal oxide-sulfur composite, said composite comprising:
carbon and at least one metal oxide, wherein said metal oxide is distributed throughout the carbon, and wherein the carbon and distributed metal oxide have a structure including a plurality of pores and channels; and
sulfur, wherein said sulfur is retained in said structure through sorption into at least a portion of said pores and channels and affinity to at least one of said metal oxide and said carbon, thereby forming a carbon-metal oxide-sulfur composite.

2. The carbon-metal oxide-sulfur composite of claim 1, wherein the mass ratio of said sulfur to said carbon-metal oxide structure is between 0.1 and 100.

3. The carbon-metal oxide-sulfur composite of claim 1, wherein said metal oxide is at least one metal oxide selected from the group consisting of titanium (IV) oxide, zirconium (IV) oxide, aluminum (III) oxide, vanadium (VI) oxide, nickel (II) oxide, magnesium (II) oxide, copper (II) oxide, chromium (III) oxide, cobalt (II) oxide, manganese (IV) oxide, iron (III) oxide, molybdenum (VI) oxide, cerium (IV) oxide, manganese (III) oxide, silicon (IV) oxide, zinc (II) oxide, boron (III) oxide, bismuth (III) oxide, and tin (II) oxide.

4. The carbon-metal oxide-sulfur composite of claim 1, wherein said metal oxide is present in an amount between 1% and 20% by weight of the total composition of the composite.

5. The carbon-metal oxide-sulfur composite of claim 1, wherein said metal oxide is amorphous.

6. The carbon-metal oxide-sulfur composite of claim 1, wherein the composite has a hierarchical pore structure comprising micropores, mesopores and marcopores.

7. The carbon-metal oxide-sulfur composite of claim 6, wherein the diameter of mesopores is between 2 nm and 20 nm, the diameter of micropores is less than 2 nm, and the diameter of macropores is larger than 20 nm.

8. The carbon-metal oxide-sulfur composite of claim 1, said composite having a BET surface area between 1900 m²/g and 3000 m²/g.

9. The carbon-metal oxide-sulfur composite of claim 1, said composite having a pore volume between 1.7 cm³/g and 10 cm³/g.

10. A carbon-metal oxide-sulfur cathode, said cathode comprising:
carbon and at least one metal oxide, wherein said metal oxide is distributed throughout the carbon, and wherein the carbon and distributed metal oxide have a structure including a plurality of pores and channels; and
sulfur, wherein said sulfur is retained in said structure through sorption into at least a portion of said pores and affinity to said metal oxide and said carbon, thereby forming a carbon-metal oxide-sulfur composite.
conductive carbon; and
polymer binder

11. The cathode of claim 10, wherein said conductive carbon is selected from the group consisting of Super P, acetylene carbon black, CNT, KS-6, V7, XC-72, EC 600D, and EC 300J.

12. The cathode of claim 10, wherein said polymer binder is selected from the group consisting of polyvinylidene fluoride (PVDF), polytetrafluoroethylene (PTFE), carboxymethyl cellulose (CMC), methyl cellulose (MC), polyvinyl alcohol (PVA), and fluorinated ethylene propylene (FEP).

13. The cathode of claim 10, wherein said carbon-metal oxide-sulfur composite is present in an amount between 1% and 92% by weight.

14. The cathode of claim 10, wherein said conductive carbon is present in an amount between 4% and 80% by weight.

15. The cathode of claim 10, wherein said polymer binder is present in an amount between 4% and 20% by weight.

16. The cathode of claim 10, wherein said carbon-metal oxide-sulfur composite is present in an amount between 1% and 92% by weight;
said conductive carbon is present in an amount between 4% and 80% by weight; and said polymer binder is present in an amount between 4% and 20% by weight

17. A battery comprising the cathode of claim 10 and an anode, said anode comprising lithium.

18. A process for preparing a carbon-metal oxide composite, comprising:
a) dissolving a pore template in the solution of metal oxide precursor, organic solvent, and acidic catalyst;
b) preparing a polymer precursor;
c) dissolving said polymer precursor in organic solvent
d) combining the pore template, organic solvent, and acidic catalyst mixture with the alcohol and polymer precursor and with a silica precursor;
e) evaporating the organic solvent from the mixture of step (d);
f) thermopolymerizing the mixture of step (e);
g) grinding the thermopolymerized composition formed in step (f);
h) calcining the composition of step (g); and
i) removing the silica from the composition of step (h), thereby forming a carbon-metal oxide composite.
j) dissolving a metal oxide precursor in a solution of organic solvent and acidic catalyst;
k) impregnating the obtained carbon-metal oxide composite in the solution of metal oxide precursor of step (i) to obtain metal oxide precursor loaded carbon-metal oxide composite;
l) calcining the product of step (k) to produce carbon-metal oxide composite.

19. The method of claim 18 wherein said metal oxide precursor is one or more selected from the group consisting of titanium (IV) isopropoxide, titanium (IV) chloride, titanium (IV) n-butoxide, zirconium (IV) isopropoxide, zirconium (IV) n-butoxide, zirconium (IV) oxychloride, aluminum (III) isopropoxide, aluminum (III) nitrate, aluminum (III) (sec-BuO)₃, ammonium metavanadate , vanadium (V) oxytrichloride, vanadium (IV) oxide bis(2,4-pentanedionate), nickel (II) chloride, nickel (II) acetate, magnesium (II) chloride, magnesium (II) nitride, magnesium (II) acetate, copper (II) nitrate, chromium (III) nitrate, cobalt (II) nitrate, cobalt (II) acetate, manganese (II) nitrate, manganese (II) acetate, iron (III) nitrate, iron (III) ethoxide, ammonium heptamolybdate tetrahydrate, peroxomolybdenum, cerium (IV) isopropoxide, cerium (IV) t-butoxide, cerium (IV) nitrate, cerium (III) chloride, cerium (III) acetate, tetramethyl orthosilicate, tetraethyl orthosilicate, tetrapropyl orthosilicate, tetrabutyl orthosilicate, zinc (II) chloride, zinc (II) nitrate, zinc (II) acetate, bismuth (III) isopropoxide, bismuth (III) chloride, bismuth (III) nitrate, bismuth (III) acetate, tin (II) chloride, and tin (II) acetate.

20. A process for preparing a carbon-metal oxide-sulfur composite, comprising:
preparing a carbon-metal oxide composite by the process of claim 18; and
impregnating sulfur in said carbon-metal oxide composite.
